(19) United States
(12) Patent Application Publication
(10) Pub. No.: US 2006/0116138 A1
(43) Pub. Date: Jun. 1, 2006

(54) VALUE ADDED SERVICES CREATION (VASC) PLATFORM

(75) Inventors: ALTUG SIMSEK, Atasehir, Istanbul (TR); CEMALETTIN BORA ELIACIK, Goztepe, Istanbul (TR); ERHAN LOKMAN, Kadikoy, Istanbul (TR); BARIS COSKUN, Ayazaga, Istanbul (TR); BURAK GORKEMLI, 4.Levent, Istanbul (TR); GOKHAN KARAKUS, Uskudar, Istanbul (TR); OZCAN OZYURT, Avcilar, Istanbul (TR); MURAT SERKANT ULUDERYA, Gungoren, Istanbul (TR); ISMAIL BAYRAKTAR, Besiktas, Istanbul (TR); BULENT KAYTAZ, Bahcesehir, Istanbul (TR)

Correspondence Address: LACASSE & ASSOCIATES, LLC, 1725 DUKE STREET, SUITE 650, ALEXANDRIA, VA, 22314, US

(73) Assignee: ARGELA TECHNOLOGIES, Maslak, Istanbul (TR)

(21) Appl. No.: 10/904,786

(22) Filed: Nov. 29, 2004

(51) Int. Cl. H04Q 7/20

(52) U.S. Cl. 455/466

(57) ABSTRACT

A method of creating messaging application services by using a drag and drop user interface without needing to write computer programs. The messaging application flow is created in VASC (Value Added Services Creation) system by using micro-service blocks which are connected together in an orderly fashion to represent a service. The service execution logic pulls an application flow based on a service request by a mobile user form a service database and executes it to provide content to the user from a content database.

### BACKGROUND OF THE INVENTION

The present invention relates generally to the field of messaging services. More specifically, the present invention is related to providing an innovative messaging services creation environment for mobile service providers and their content providers.

### DISCUSSION OF PRIOR ART

Nowadays many mobile operators offer revenue-generating messaging services to their customers using short messaging service (SMS) or multimedia messaging service (MMS). With these services, the user usually uses the short messaging service (SMS) to type text on his/her cell phone and a service number, and sends it to the operator's network. A messaging server in the operator's network receives the text message, and parses it to obtain the calling party telephone number and the service number. Typical messaging servers are SMS Center (SMSC), which processes SMS messages, and MMS Center (MMSC), which processes MMS messages. Based on the service number to which the text message is targeted, the messaging server responds with a specific content by simply originating an SMS towards the calling party with the content as message text. Doing so, the user receives a response to the SMS he/she sends. An example service is querying for the weather in a city. The user sends an SMS with a specific service name (or number), say weather_request, and city_name:

Request Message: weather_request Istanbul

In response, the operator's messaging server performs the lookup for weather in Istanbul for that day and returns a message back in the form of an SMS to the user as follows:

Response Message: weather_request sunny_h18_I15

The service carrier that carries a request message is called a request channel. A request channel can be SMS, MMS, or email for example. Similarly, the service carrier that carries a response message is called the delivery channel. Again, the delivery channel can be SMS, MMS, or email for example. The request and delivery channels do not need to be the same for a set of request/response messages. There are hundreds and sometimes thousands of such services offered by mobile operators.

During recent years, mobile operators opened up their messaging infrastructure to value added service providers (VASP) (sometimes referred as content providers), who have specific content of interest to communities, to offer innovative services. Each VASP attaches to a mobile operator's network via the public Internet to use the operator's network infrastructure to deliver such services to the operator's users. The VASP simply demands a unique service number or name from the operator, and using this service number the operator can identify incoming messages as being destined to that specific VASP and routes the message to the VASP's network for further processing. In turn, the VASP processes the incoming SMS and responds with another SMS towards the operator's network. In this scenario, operator uses the messaging servers within its network to relay the message to the user.

Creating such services by VASPs or mobile operators (when the content is owned by the operator) has been manual so far. Meaning, the VASP learns the SMS protocols such as SMPP, CIMD, or UCP, and writes programs to parse incoming SMS messages to gather the information in it. It also writes programs to perform appropriate string operations and database lookups to return the requested information, and to send a response message back. This method has not been efficient as many content owners do not know how to write computer programs and, even if they can write these programs, many find it difficult to learn sophisticated messaging protocols designed for the operator's core network.

FIG. 1 demonstrates a prior art system for building a messaging service. There are three distinct applications, namely Horoscope, Logo/Melody download, and Weather Channel. The content for these three applications are stored in databases 101, 102, and 103 respectively. These databases can be in the mobile operator's network or alternatively in one or more VASP networks. The mobile operator has three SMS centers which process SMS messages 301, 302, and 303, respectively. For the Horoscope service 101, the mobile operator (or VASP) writes an application 201 which communicates with all three SMSC's using links 701, 702, and 703. For these links, the application program 201 uses delivery channels such as SMPP, CIMD, or UCP over TCP/IP. The application program 201 can parse incoming SMS messages and perform database lookup using link 601 into the horoscope database. Similarly, for the Logo/Melody service 102, the mobile operator (or VASP) writes an application 202 which communicates with all three SMSCs. For these links, the application program 202 uses SMS protocols such as SMPP, CIMD, or UCP for the response channel. The application program 202 can parse incoming SMS messages and perform database lookup using link 602 into the logo/melody database. It is obvious from this example that each time there is a new service generated, the mobile operator or the VASP will need to write new code (although it may reuse components of the prior code) to support the new service. This process greatly slows down the process of new service creation.

Whatever the precise merits, features, and advantages of the above cited system, it does not achieve or fulfill the purposes of the present invention.

### SUMMARY OF THE INVENTION

A method of creating messaging application services uses a drag and drop user interface to create messaging application flows by connecting micro-service blocks in an orderly fashion to represent a service. The service execution logic extracts an application flow based on a service request by a mobile user form a service database and executes it to provide content to the user from a content database. The drag and drop interface, service execution logic program and service database are part of a Value Added Service Creation (VASC) platform. The VASC system either resides at a mobile operators' network or a content providers' network.

### BRIEF DESCRIPTION OF THE DRAWINGS

FIG. 1 illustrates a prior art system for building a messaging service.

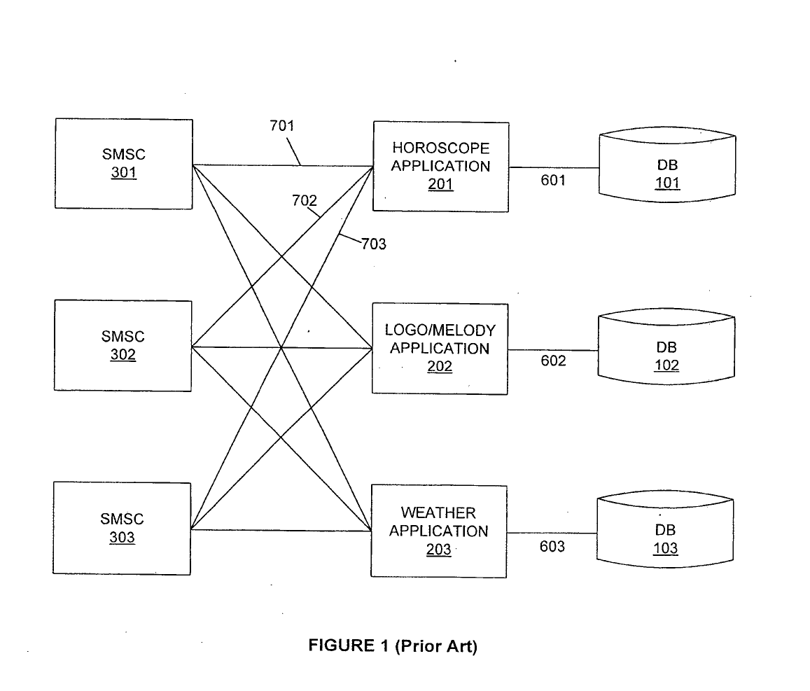

FIG. 2 illustrates the Value Added Services Creation (VASC) platform, as per the present invention.

FIG. 3a illustrates a simplified block diagram of a software system with no abstractor where the VASC is at the Operator's network.

FIG. 3b illustrates a simplified block diagram of a software system with no abstractor where the VASC is at the VASP's network.

FIG. 3c illustrates a simplified block diagram of a software system with an abstractor where the abstractor is at the mobile operator's network and the VASC is at the VASP's network.

FIG. 4 illustrates the value added service execution logic, as per the present invention.

FIG. 5 illustrates an example Service Creation Environment (SCE), as per the present invention.

FIG. 6 illustrates an exemplary Micro-Service Block (MSB) for database query and its properties.

FIG. 7 illustrates an exemplary process of creating a new messaging service through the system.

FIG. 8 illustrates an exemplary process of running a messaging service through the system.

FIG. 9 illustrates an exemplary process for executing the service logic for a horoscope service.

FIG. 10 illustrates a VASC monitoring tool GUI screenshot.

### DESCRIPTION OF THE PREFERRED EMBODIMENTS

While this invention is illustrated and described in a preferred embodiment, the invention may be produced in many different configurations. There is depicted in the drawings, and will herein be described in detail, a preferred embodiment of the invention, with the understanding that the present disclosure is to be considered as an exemplification of the principles of the invention and the associated functional specifications for its construction and is not intended to limit the invention to the embodiment illustrated. Those skilled in the art will envision many other possible variations within the scope of the present invention.

The present invention provides a system, referred to throughout the specification as a Value Added Services Creation (VASC) platform, by which messaging application services can be created using a drag and drop user interface without needing to write computer programs. Furthermore, the same system can be used to create many services. Meaning, it avoids writing different programs for each service. The messaging applications include, but are not limited to, Horoscope, Logo/Melody download, and Weather applications. Moreover, the present invention can be applied to any messaging application that is used to provide content to a mobile user.

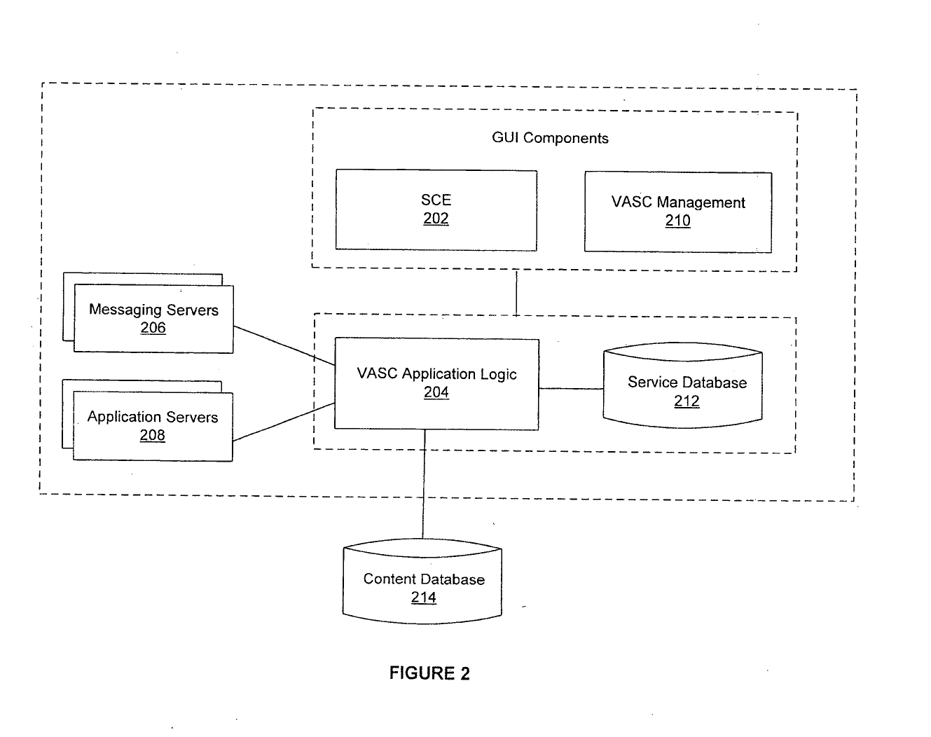

As shown in FIG. 2, the VASC platform has several components: the Service Creation Environment (SCE), the user interface 202 which contains the Micro-Service Blocks (MSB), VASC service/application execution logic 204, messaging servers 206, application servers 208, service database 212, content database 214, and VASC content management interface 210. The VASC system may optionally include network management components for managing and maintaining the system. The messaging servers and content database may be separate systems that are not part of the VASC system. Thus, the SCE GUI, service execution logic, and service database are three components included in the VASC system, and the other components such as content database, servers etc., can be located remotely or separate from the VASC system. The VASC system attaches to one or more content providers' content management systems to deliver content to operators' users.

The content management system may reside with one or more content providers that attach to VASC remotely using public Internet or private connections. The content database may be a large-scale database that stores text or binary (e.g. logo, music or images) content which is periodically updated and kept current by the content provider. The content management interface 210 defines the content exchange process between the operator and the content provider. The content exchange process defines the transaction handling of data pull/push, QoS, security levels, and Service Level Agreements (SLAs) along the interface between the content provider and the operator.

Various ways to access the content database of the content provider are supported by the VASC platform. First is the file system. If the content is stored as files in the local or remote file system, data can be retrieved by ordinary file operations of the operating system. Second is the Hypertext Transfer Protocol (HTTP). If the content is on a web page on the Internet or the content provider opens its content database to its customers via HTTP Get requests, the service creator can access it during service execution. A third way of accessing the content provider database is the File Transfer Protocol (FTP). The content to be provided to the user may be downloaded either by the HTTP or by the FTP and can be attached to outgoing user notifications, such as e-mail or MMS.

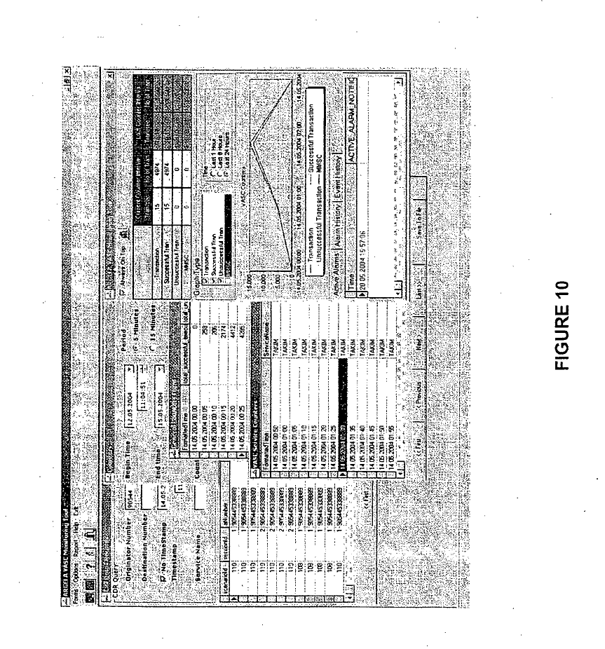

The operator can interface to the VASC system for network monitoring by a Command Line Interface (CLI) or a Graphical User Interface (GUI). CLI is a powerful administrator interface to the system. It opens configuration management, performance analysis, reporting and administration commands to the user. GUI is for statistical data collection purposes. It collects performance counters, displays them, and creates graphical reports that give the user the status of the VASC platform, such as how many requests were generated in the last 24 hours, how many of them succeeded, how many of them failed, etc. FIG. 10 shows a screenshot of the VASC monitoring tool GUI.

The VASC is attached to the messaging and application servers using open interfaces over the TCP/IP protocol. Doing so, VASC can attach to any vendor's SMSC, email, or MMSC servers. The example protocols on the SMSC interface are UCP and SMPP protocol. The example protocol on the email server interface is SMTP, and MM7 on the MMSC interface. The messaging servers include, but are not limited to, email servers, short messaging service centers (SMSCs), multi-media messaging service centers (MMSCs), and Wireless Access Protocol (WAP) gateways. The application servers include, but are not limited to, Web Servers, Video Streaming Servers, Chat Servers, and Interactive Voice Response (IVR) systems. The messaging servers are used to send and receive messages between the user's cell phone and the operator using different messaging types. These messaging types include email, SMS, MMS, phone call, chat message, etc.

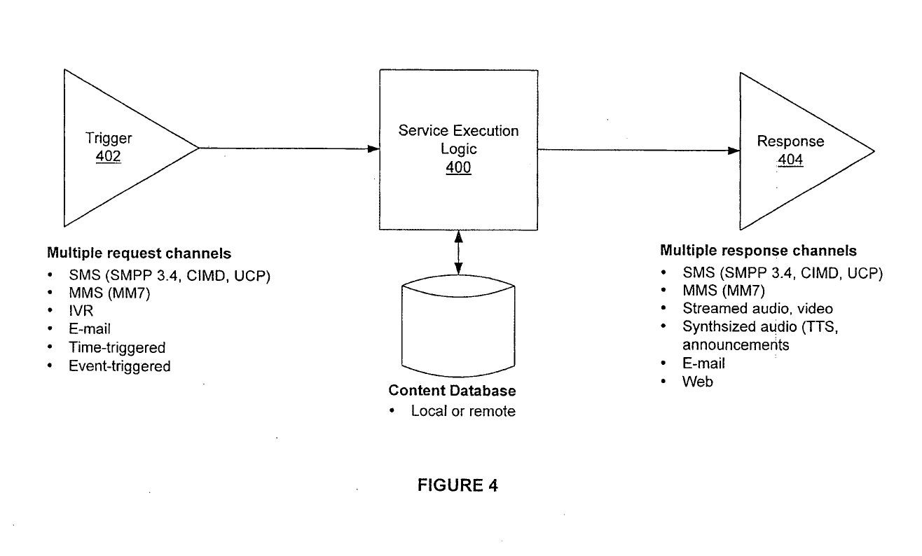

The mobile operator can use the system to create a new messaging application, which defines the messaging technology and message content from the user's cell phone to the operator and content provider (trigger), and from the operator and content provider to the user's cell phone (response). An example application is one in which the user triggers the service by sending a Short Messaging Service (SMS) message using his/her cell phone to the operator defined number requesting particular data, video, or image (e.g. logo). FIG. 4 shows the service execution logic 400 receiving service triggers 402 from the user and sending a response 404 to the user via multiple request and delivery channels. SMPP, MM7, WAP, SNMP, UCP and CIMD are some examples of request and delivery channels. However, other protocols for request and delivery channels may also be used.

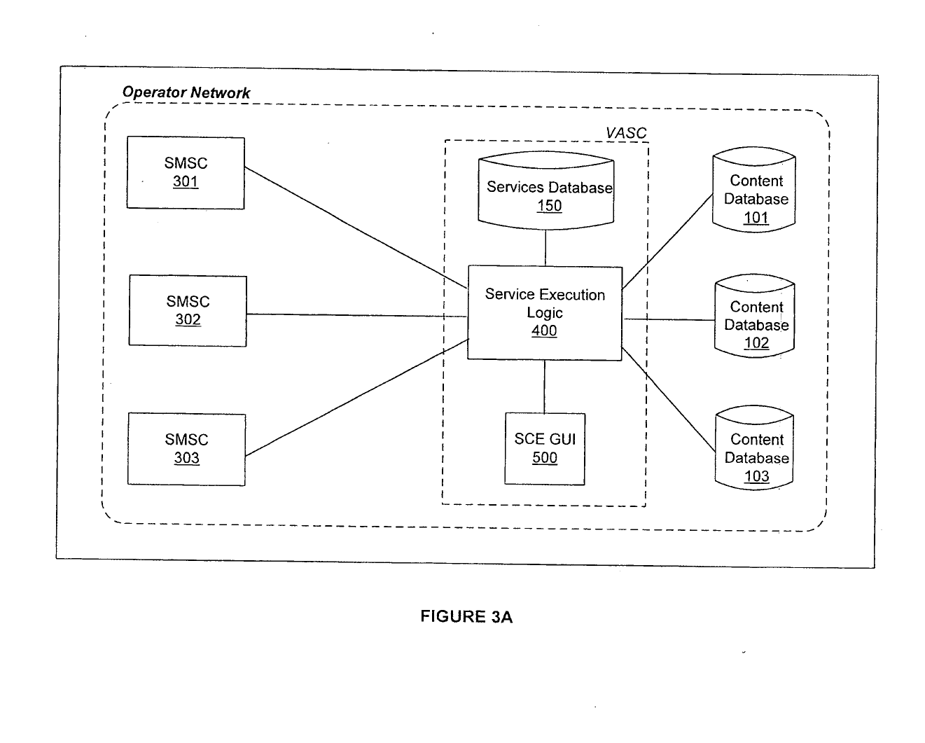

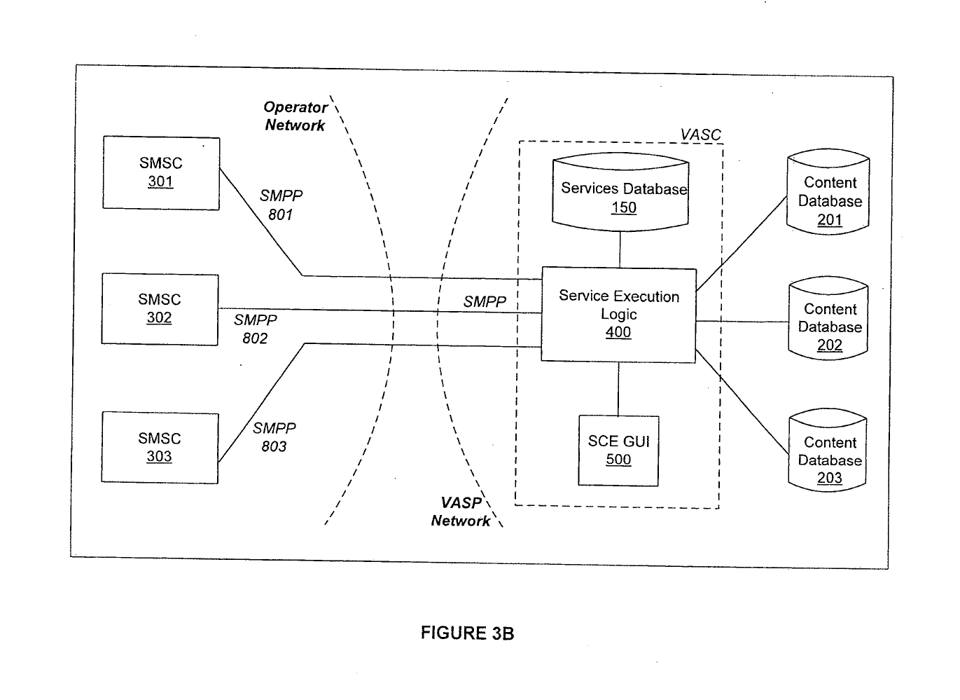

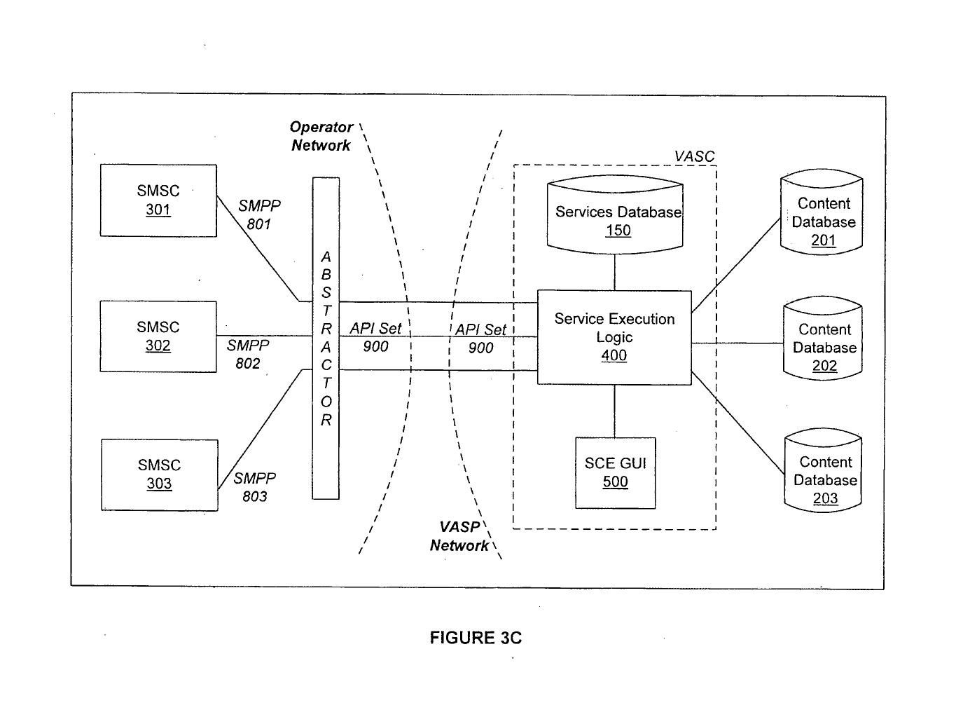

With respect to FIG. 3a, the SMS sent by the user is delivered to one of the SMS service centers, say SMSC 301. SMSC 301 then forwards this message to the VASC Service Execution Logic 400 via the SMPP connection 801. When the VASC Service Execution Logic 400 receives this message, it fetches the requested service logic from the services database 150 and executes it. The service logic may vary but, in this case, it is a push-pull service and the content to be sent back to the originating subscriber is fetched from one of the content databases, say content database 101. VASC Service Execution Logic 400 creates a new SMS, sends it to SMSC 302 via SMPP connection 802 and it is delivered back to the subscriber. In this example, the subscriber requested particular data, say video or image, and the operator responded back with an SMS which contains the URL that specifies the location of the data. This service may also create an email message to the user's mailbox with the same information. Another example service is one in which the user sends an SMS to the operator specified number requesting his/her daily horoscope. The operator responds to the message with an SMS which contains a text of the daily horoscope. This invention pieces the incoming and outgoing messaging technologies, message content, content providers, and other messaging details together to instantly create and provide a messaging service that the operator can offer to its users.

The VASC system may also be used to create and execute timed tasks such as “Remind Me” and “Wake Up.” These tasks do not require responses instantly as in the example above. If the user wants to be reminded of a chore at a later time or needs to be woken up at a particular time, he can create an application flow in the VASC system such that a response is sent to him at the set time.

The VASC system normally attaches to one or more content providers' content management systems to deliver content to operators' users. The VASC system may be positioned in three different places in a typical telecom provider—service provider network.

The VASC system may be deployed in the operator's network as shown in FIG. 3a. In this case, the VASC communicates with the messaging servers of the operator via direct connections using native telecom protocols such as SMPP, UCP, CIMD, and MM7. The operator will be the one operating the VASC. Content databases may either be part of operator's network or provided by third parties.

The VASC system may be deployed in the Value Added Service Provider's network as shown in FIG. 3b without an abstractor in the operator network. In this case, the VASC communicates with the messaging servers of the operator via direct connections using native telecom protocols such as SMPP, UCP, CIMD, and MM7. The VASP owning the VASC will be operating it. Content databases are also on the VASP's network.

The VASC system may be deployed in the Value Added Service Provider's network as shown in FIG. 3c with an abstractor present in the operator network. In this case, the VASC does not communicate with the messaging servers of the operator via direct connections using native telecom protocols such as SMPP, UCP, CIMD, and MM7. Instead, VASC will only have a connection with the abstractor of the operator and it will communicate with the operator via either operator defined proprietary API or open API, such as PARLAY, defined by international telecom bodies. The abstractor thus, generalizes and abstracts the request and delivery channel protocols using the API set. The abstracted representation, in the form of XML or text files, may be transmitted using TCP/IP, RPC or HTTP protocols. The abstractor is in charge of converting the APIs to native protocols that can be understood by messaging servers in the operator network. The abstractor behaves both like a gateway and a firewall in the operator network: regulating the access of different VASPs to the internal network, checking Service Level Agreements (SLAs) made by the VASPs, converting the API set to native protocols, etc. The VASP owning the VASC will be operating it. Content databases are on the VASP's network.

The first model is useful when the operator itself wants to own the service it gives. It was the model commonly used by the operators in early times of GSM revolution. The second model is commonly used today. It lacks control of the operator on the VASPs. The third model, in which the operator does not give any service but has full control over the VASPs that give service by using its network, is gaining importance.

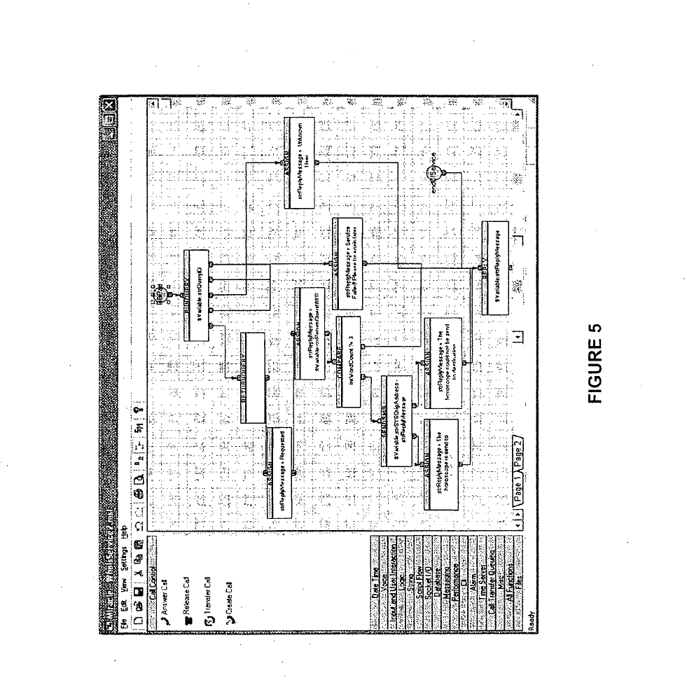

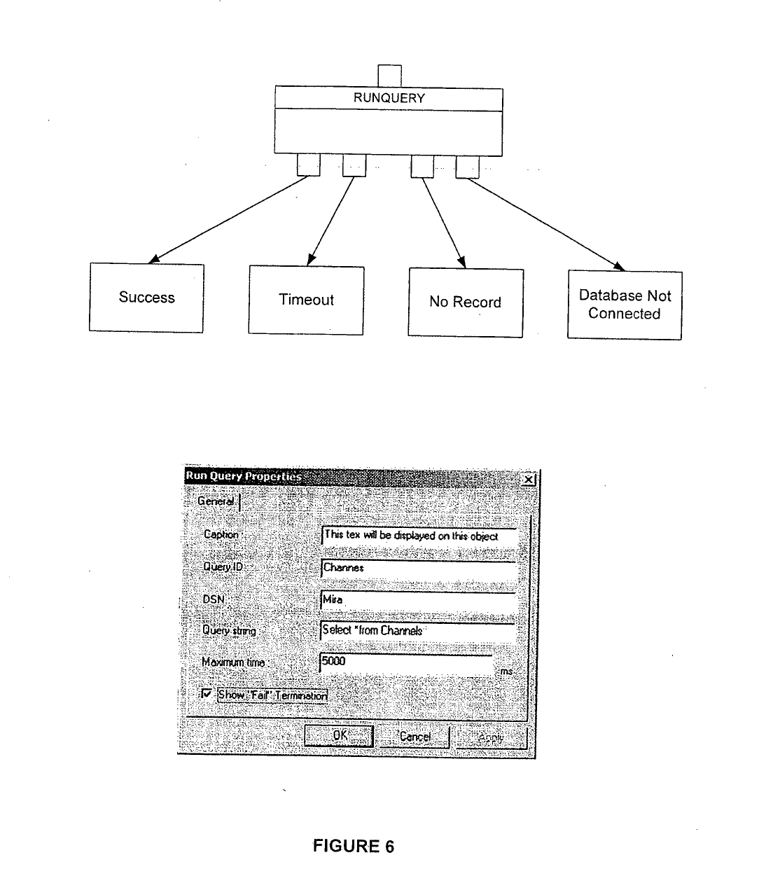

With respect to FIG. 5, the VASC service creation environment is a drag and drop Graphical User Interface that uses Micro-Service Blocks (MSB) (an example of which is shown in FIG. 6), each of which defines a specific atomic service/application creation operation. MSBs are like the bricks of a building. By using standard MSBs, the service creator can define a service any way he/she wants. Every MSB has an infinitesimal functionality. For example, a group of MSBs performs database operations such as database connection creation and lookup. Another group performs user notification operations such as returning a reply to the service requesting subscriber over the transport media that the service request came from; sending e-mail, MMS, and SMS messages to third party subscribers; etc. It can also perform activation of the service delivery channels. Yet another group performs string operations such as cut, paste, compare, and search. FIG. 6 shows an MSB for a database query and its properties. Execution of the query can provide any of the following results: success, timeout, no record, and database not found. Thus, while creating a service, a decision on how to connect MSBs can be made based on the results produced by the execution of each MSB.

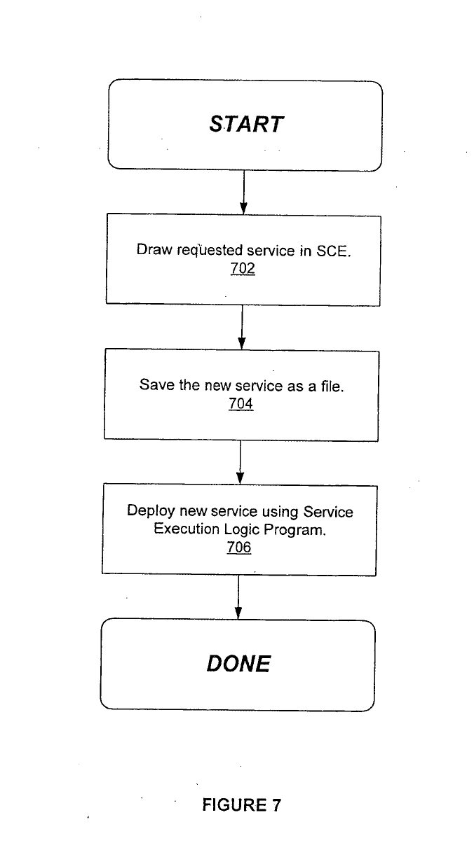

By placing and connecting the MSBs that the designer/user wants for the required functionality in an orderly fashion, a messaging application/service flow for a service is created. FIG. 7 shows the process of creating a new messaging application. In step 702, the MSBs are drawn and connected to represent an application. After that, the user saves the new flow as a file on the VASC platform (in the service database) in step 704. In step 706, the new service is deployed by the service execution logic program.

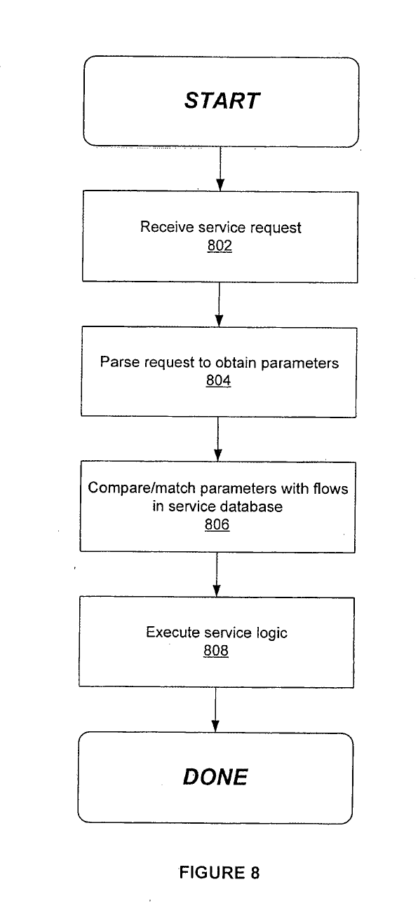

FIG. 8 shows a process of running a messaging application/service in the VASC system. The service execution logic receives a service request from the user in step 802. In case the VASC is part of the system shown in FIG. 3c, the VASC receives an abstracted representation of the service request through the abstractor. The service request is parsed to obtain user parameters such as sending party identifier and service number in step 804. In step 806, the user parameters are compared and matched with the application flows saved in the service database. The appropriate application flow pulled from the service database is executed by the service execution logic program to provide the service in step 808. The service execution logic translates the messaging application flow into actual programs to realize the messaging service. Upon execution, appropriate content is pulled from the content databases and a response is provided to the user who requested the service. The response may also be in an abstracted form through the abstractor in FIG. 3c.

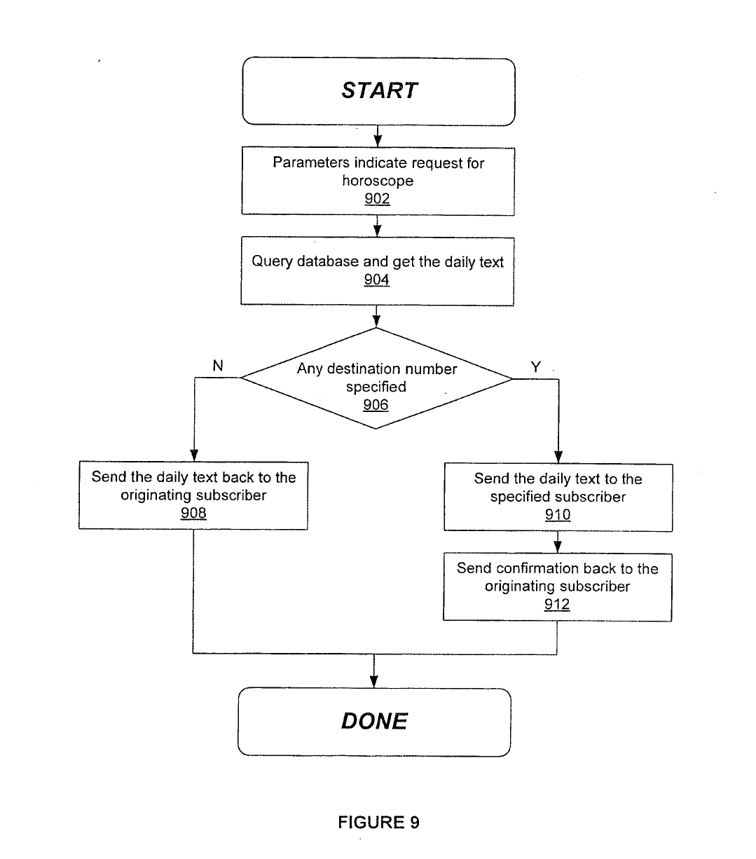

FIG. 9 shows how an example horoscope application is executed by the service execution logic program. Parameters received from a service request indicate that the user has requested a horoscope service as in step 902. The service execution logic executes the application flow for the horoscope service wherein a content database is queried to get appropriate text as in step 904. In step 906, a decision is made as to whether the parameters provide a destination number where the response needs to be sent. In case no destination number is specified, the response is sent to the user who originated the request as in step 908. However, in case a destination number is specified, the response is sent to the specified user as in step 910 and a confirmation is sent to the user who originated the request as in step 912.

As a system, the Value Added Services Creation (VASC) environment is a fully integrated telecom service development and production system. It incorporates a fully integrated Service Creation Environment (SCE); powerful, N+1 redundant and linearly scalable service execution engine; and fully integrated O&M tools with GUI access. It supports many ways to request a service (e.g., SMS, email, MMS and web requests) and, upon execution of the requested service logic, it returns the content to the service requester or third parties in many ways (e.g., SMS, email, and MMS). It supports timed tasks to deliver services like “Remind Me” and “Wake Up.”

Additionally, the present invention provides for an article of manufacture comprising computer readable program code contained within implementing one or more modules to create a messaging application/service. Furthermore, the present invention includes a computer program code-based product, which is a storage medium having program code stored therein which can be used to instruct a computer to perform any of the methods associated with the present invention. The computer storage medium includes any of, but is not limited to, the following: CD-ROM, DVD, magnetic tape, optical disc, hard drive, floppy disk, ferroelectric memory, flash memory, ferromagnetic memory, optical storage, charge coupled devices, magnetic or optical cards, smart cards, EEPROM, EPROM, RAM, ROM, DRAM, SRAM, SDRAM, or any other appropriate static or dynamic memory or data storage devices.

Implemented in computer program code based products are software modules for: (a) drag and drop interface for creating a messaging application flow; and (b) service execution logic to translate the application flow into actual programs to realize the messaging service.

### CONCLUSION

A system and method has been shown in the above embodiments for the effective implementation of a Value Added Services Creation (VASC) Platform. While various preferred embodiments have been shown and described, it will be understood that there is no intent to limit the invention by such disclosure, but rather, it is intended to cover all modifications falling within the spirit and scope of the invention, as defined in the appended claims. For example, the present invention should not be limited by software/program, computing environment, messaging applications, or specific computing hardware.

The above enhancements are implemented in various computing environments. For example, the present invention may be implemented on a conventional IBM PC or equivalent, multi-nodal system (e.g., LAN), or networking system (e.g., Internet, WWW, wireless web). All programming and data related thereto are stored in computer memory, static or dynamic, and may be retrieved by the user in any of: conventional computer storage, display (i.e., CRT), and/or hardcopy (i.e., printed) formats. The programming of the present invention may be implemented by one of skill in the art of graphics or object-oriented programming.

What is claimed is:

1. A system for creating a messaging service on a mobile network, said system comprising:
a drag and drop user interface using micro-service blocks to create a messaging application flow;
a service database storing said messaging application flow; and
a service logic program translating said messaging application flow to computer programs to implement said messaging service.

2. A system for creating a messaging service, according to claim 1, wherein a content database is locally or remotely attached to said system.

3. A system for creating a messaging service, according to claim 2, wherein said content database stores content delivered to a user upon executing said messaging application flow.

4. A system for creating a messaging service, according to claim 1, wherein said service logic program receives a service request trigger on a request channel from a user and delivers a service response on a delivery channel to a user.

5. A system for creating a messaging service, according to claim 4, wherein said service trigger or service response is sent or delivered as messages from and to messaging servers using any one of the following messaging types: email, SMS, MMS, phone call, and chat message.

6. A system for creating a messaging service, according to claim 4, wherein said request channel or delivery channel uses any one of the following protocols: SMPP, MM7, WAP, SNMP, UCP, and CIMD.

7. A system for creating a messaging service, according to claim 1, wherein said system resides in a mobile operators' network.

8. A system for creating a messaging service, according to claim 1, wherein said system resides in a content providers' network and connects to a mobile operators' network using the Internet.

9. A system for creating a messaging service, according to claim 8, wherein said system includes an abstractor at the mobile operators' network to: generalize and abstract request/delivery channel protocols using an Application Programming Interface (API) set; and deliver said messaging service using an abstracted representation of the request and delivery channels to conceal native protocols.

10. A system for creating a messaging service, according to claim 9, wherein said abstracted representation is transmitted using any one of the following protocols: TCP/IP, RPC, and HTTP.

11. A system for creating a messaging service, according to claim 9, wherein said abstracted representation is any one of the following: XML files and text files.

12. A system for creating a messaging service, according to claim 9, wherein said Application Programming Interface (API) is PARLAY.

13. A system for creating a messaging service, according to claim 1, wherein said micro—service block performs string operations such as cut, paste, compare, and search.

14. A system for creating a messaging service, according to claim 1, wherein said micro-service block performs service delivery channel activation.

15. A system for creating a messaging service, according to claim 1, wherein said micro-service block performs database lookup or write operations.

16. A system for creating a messaging service, according to claim 1, wherein said micro-service block forks decisions and can connect to other micro-service blocks to generate said messaging application flow.

17. A system for creating a messaging service, according to claim 1, wherein said system is used to generate a new service.

18. A method of delivering a messaging service to a mobile user located within a mobile operators' network, said method comprising:
receiving a messaging service request on a request channel from said mobile operator's network;
parsing said messaging service request to obtain parameters for said request;
comparing and matching said parameters with application flows stored in a service database; and
running a service logic program to execute said application flows to implement said messaging service, wherein said service logic program
performs content lookup in a content database;
generates a messaging service response with content obtained from said content database; and
sends said messaging service response on a delivery channel to said mobile user through said mobile operators' network.

19. A method of delivering a messaging service to a mobile user, according to claim 18, wherein said mobile operators network includes an abstractor to: generalize and abstract request/delivery channel protocols using an Application Programming Interface (API) set; and deliver said messaging service using an abstracted representation of the request and delivery channels to conceal native protocols.

20. A method of delivering a messaging service to a mobile user, according to claim 19, wherein said abstracted representation is transmitted using any one of the following protocols: TCP/IP, RPC, and HTTP.

21. A method of delivering a messaging service to a mobile user, according to claim 19, wherein said abstracted representation is any one of the following: XML files and text files.

22. A method of delivering a messaging service to a mobile user, according to claim 19, wherein said Application Programming Interface (API) is PARLAY.

23. A method of delivering a messaging service to a mobile user, according to claim 18, wherein said service request or service response is sent or delivered as messages from and to messaging servers using any one of the following messaging types: email, SMS, MMS, phone call, and chat message.

24. A method of delivering a messaging service to a mobile user, according to claim 18, wherein said request channel or delivery channel uses any one of the following protocols: SMPP, MM7, WAP, SNMP, UCP, and CIMD.

25. A method of delivering a messaging service to a mobile user, according to claim 18, wherein said application flows are created using micro-service blocks connected via a drag and drop interface.

26. A method of delivering a messaging service to a mobile user, according to claim 25, wherein said micro-service blocks perform service delivery channel activation.

27. A method of delivering a messaging service to a mobile user, according to claim 25, wherein said micro-service blocks perform database lookup or write operations.

28. A method of creating a messaging service, said method comprising:
creating a messaging application flow by connecting micro-service blocks using a drag drop interface;
storing said messaging application flow in a service database; and
deploying said messaging service through a service logic program by executing said messaging application flow.

29. A system for delivering a messaging service to a mobile user, said system comprising:
a service creation platform, said platform:
receiving a messaging service request from a mobile user through a messaging server;
parsing said messaging service request to obtain parameters for said request;
comparing and matching said parameters with application flows stored in a service database;
executing said application flow by running a service logic program; and
generating a messaging service response,
a content database storing content that is extracted by said service logic program to generate said messaging service response; and
a messaging server delivering said messaging service response to said mobile user.

30. A system for delivering a messaging service to a mobile user, according to claim 29, wherein said service creation platform is part of a mobile operators' network or a content providers' network.

31. An article of manufacture comprising a computer usable medium having computer readable code embodied therein which creates a messaging service and delivers the service to a mobile user, said medium comprising:
computer readable program code for creating a messaging application flow by connecting micro-service blocks using a drag drop interface;
computer readable program code for storing said messaging application flow in a service database;
computer readable program code for implementing a service logic program, said service logic program comprising;
computer readable program code for receiving a messaging service request from a mobile user through a messaging server;
computer readable program code for parsing said messaging service request to obtain parameters for said request;
computer readable program code for comparing and matching said parameters with said application flow stored in said service database;
computer readable program code for executing said application flow;
computer readable program code for generating a messaging service response by extracting content from a content database; and
computer readable program code for delivering said messaging service response to said mobile user.
